(19) United States
(12) Patent Application Publication
(10) Pub. No.: US 2025/0311903 A1
(43) Pub. Date: Oct. 9, 2025

(54) Laundry Room Vacuum Device

(71) Applicant: Brian Cravenho, Pixley, CA (US)

(72) Inventor: Brian Cravenho, Pixley, CA (US)

(21) Appl. No.: 19/084,936

(22) Filed: Mar. 20, 2025

Related U.S. Application Data
(60) Provisional application No. 63/631,477, filed on Apr. 9, 2024.

(51) Int. Cl. A47L 9/12; A47L 9/00; A47L 9/14; A47L 9/24; B01D 46/52; D06F 58/22

(52) U.S. Cl. CPC A47L 9/12; A47L 9/0081; A47L 9/1409; A47L 9/248; B01D 46/521; D06F 58/22

(57) ABSTRACT

A laundry room vacuum device is provided. The device is comprised of a wall-mounted central vacuum with a housing that includes sound-dampening panels to reduce motor noise and vibration. The central unit comprises a high-efficiency, low-noise motor designed to operate below 60 decibels and a multi-stage filtration system featuring a HEPA-rated primary filter for capturing fine particles and a washable mesh filter for larger debris. The device further comprises a reinforced, crush-resistant vacuum hose with a smooth internal lining to minimize airflow turbulence, an adjustable spring-coil retraction mechanism for tangle-free storage, and various nozzle attachments tailored for specific cleaning tasks, such as a tapered crevice tool, a wide lint nozzle, and a bristled brush attachment. A storage compartment within the housing secures the nozzle attachments using flexible fasteners, while a detachable lint disposal bin with a quick-release latch and anti-static, transparent construction facilitates convenient monitoring and disposal.

### CROSS-REFERENCE TO RELATED APPLICATION

The present application claims priority to, and the benefit of, U.S. Provisional Application No. 63/631,477, which was filed on Apr. 9, 2024, and is incorporated herein by reference in its entirety.

### FIELD OF THE INVENTION

The present invention relates generally to the field of vacuums. More specifically, the present invention relates to a wall-mounted central vacuum with sound-dampening panels to reduce motor noise and vibration, a low-noise motor, and a multi-stage filtration system with a HEPA-rated primary filter and washable mesh filter for debris. Additional features include a crush-resistant vacuum hose with a smooth lining to minimize airflow turbulence, an adjustable retraction mechanism, various specialized nozzle attachments, and a storage compartment with flexible fasteners for attachments, alongside a detachable lint disposal bin with a transparent, anti-static design. Accordingly, the present disclosure makes specific reference thereto. Nonetheless, it is to be appreciated that aspects of the present invention are also equally applicable to other like applications, devices, and methods of manufacture.

### BACKGROUND

Maintaining the cleanliness of laundry systems is essential for preventing operational inefficiencies and potential hazards. Homeowners often encounter challenges when attempting to remove lint buildup from dryer filters and surrounding areas using traditional shop vacuums or wet vac systems. These vacuums may lack the necessary power or appropriate attachments to thoroughly clean lint filters and dryer interiors, leading to incomplete debris removal. Failure to routinely clear lint can result in blockages that reduce airflow efficiency and increase drying times, elevating energy costs. More critically, excessive lint accumulation poses a significant fire risk, as lint is highly flammable and can ignite when exposed to the high heat generated during dryer operation. Additionally, dust and lint particles dispersed during cleaning can degrade indoor air quality, exacerbating respiratory concerns for individuals with sensitivities or allergies.

Therefore, there exists a long-felt need in the art for the laundry room vacuum device that provides an integrated wall-mounted vacuum system capable of delivering sufficient suction to remove lint from dryer filters and surrounding areas effectively. There also exists a long-felt need in the art for the laundry room vacuum device that features specialized vacuum head attachments designed to reach narrow spaces and clean surfaces without dispersing lint or dust into the air. Moreover, there exists a long-felt need in the art for the laundry room vacuum device that minimizes operational noise and offers convenient storage for cleaning accessories, enhancing ease of use and promoting regular maintenance practices.

The subject matter disclosed and claimed herein, in one embodiment thereof, comprises a laundry room vacuum device. The device is comprised of a wall-mounted central vacuum with a housing that includes sound-dampening panels to reduce motor noise and vibration. The central unit comprises a high-efficiency, low-noise motor designed to operate below 60 decibels and a multi-stage filtration system featuring a HEPA-rated primary filter for capturing fine particles and a washable mesh filter for larger debris. The device further comprises a reinforced, crush-resistant vacuum hose with a smooth internal lining to minimize airflow turbulence, an adjustable spring-coil retraction mechanism for tangle-free storage, and various nozzle attachments tailored for specific cleaning tasks, such as a tapered crevice tool, a wide lint nozzle, and a bristled brush attachment. A storage compartment within the housing secures the nozzle attachments using flexible fasteners, while a detachable lint disposal bin with a quick-release latch and anti-static, transparent construction facilitates convenient monitoring and disposal.

In this manner, the laundry room vacuum device of the present invention accomplishes all the forgoing objectives and provides a wall-mounted central vacuum equipped with a high-efficiency, low-noise motor and a multi-stage filtration system capable of capturing fine particles and allergens. The system's detachable and washable mesh pre-filter prevents premature clogging of the HEPA-rated primary filter, ensuring consistent performance. The reinforced, crush-resistant vacuum hose extends easily and retracts via a spring-coil mechanism, preventing tangles and ensuring durability. Specialized nozzle attachments, including a crevice tool, wide lint nozzle, and bristled brush, facilitate targeted cleaning of dryer vents, lint filters, and surrounding areas. Additionally, the integrated storage compartment securely holds nozzle attachments, while the detachable lint disposal bin, featuring a transparent, anti-static design, enables users to monitor and empty collected debris efficiently. By addressing noise reduction, effective suction, and user convenience, the device provides a comprehensive solution to laundry system maintenance, promoting both safety and cleanliness.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a laundry room vacuum device designed to enhance the cleaning and maintenance of laundry areas. The device comprises a wall-mounted central unit with a housing that includes sound-dampening panels to minimize motor noise and vibration. The central unit contains a high-efficiency, low-noise motor that provides suction while maintaining low operational noise and a multi-stage filtration system. The filtration system includes a HEPA-rated primary filter for capturing fine particles and a washable stainless steel mesh filter for larger debris, preventing premature clogging.

The device features a crush-resistant vacuum hose made of reinforced polymer, with a smooth internal lining to reduce airflow turbulence and a textured exterior for improved grip. The hose is adjustable in length via a spring-coil retraction mechanism that allows controlled retraction into a storage compartment.

Multiple hose nozzle attachments are provided for specific cleaning tasks, including a narrow crevice tool for confined spaces, a wide lint nozzle for larger debris, and a bristled brush for gentle surface cleaning. The attachments can be secured via a snap-fit mechanism for easy replacement and storage in an integrated compartment within the housing, which includes flexible grips to hold attachments in place.

A detachable lint disposal bin with a quick-release latch is positioned below the central unit. The bin is transparent for fill-level monitoring and constructed of anti-static material to prevent lint adherence, with a carry handle for convenient disposal. The central unit is powered by a standard 120V electrical outlet via a power cord.

Accordingly, the laundry room vacuum device of the present invention is particularly advantageous as it provides a wall-mounted central vacuum equipped with a high-efficiency, low-noise motor and a multi-stage filtration system capable of capturing fine particles and allergens. The system's detachable and washable mesh pre-filter prevents premature clogging of the HEPA-rated primary filter, ensuring consistent performance. The reinforced, crush-resistant vacuum hose extends easily and retracts via a spring-coil mechanism, preventing tangles and ensuring durability. Specialized nozzle attachments, including a crevice tool, wide lint nozzle, and bristled brush, facilitate targeted cleaning of dryer vents, lint filters, and surrounding areas. Additionally, the integrated storage compartment securely holds nozzle attachments, while the detachable lint disposal bin, featuring a transparent, anti-static design, enables users to monitor and empty collected debris efficiently. By addressing noise reduction, effective suction, and user convenience, the device provides a comprehensive solution to laundry system maintenance, promoting both safety and cleanliness. In this manner, the laundry room vacuum device overcomes the limitations of existing vacuums known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a front view of one potential embodiment of a laundry room vacuum device of the present invention in accordance with the disclosed architecture; and

FIG. 2 illustrates a front view of hose nozzle attachments of one potential embodiment of a laundry room vacuum device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for the laundry room vacuum device that provides an integrated wall-mounted vacuum system capable of delivering sufficient suction to remove lint from dryer filters and surrounding areas effectively. There also exists a long-felt need in the art for the laundry room vacuum device that features specialized vacuum head attachments designed to reach narrow spaces and clean surfaces without dispersing lint or dust into the air. Moreover, there exists a long-felt need in the art for the laundry room vacuum device that minimizes operational noise and offers convenient storage for cleaning accessories, enhancing ease of use and promoting regular maintenance practices.

The present invention, in one exemplary embodiment, is comprised of a laundry room vacuum device designed to improve cleaning and maintenance of laundry areas. The device includes a wall-mounted central unit with a housing that incorporates sound-dampening panels to reduce motor noise and vibration. The central unit houses a high-efficiency, low-noise motor that provides suction with minimal operational noise and features a multi-stage filtration system. The filtration system comprises a HEPA-rated primary filter to capture fine particles and a washable stainless steel mesh filter for larger debris to prevent premature clogging.

The device is equipped with a crush-resistant vacuum hose constructed from reinforced polymer, featuring a smooth internal lining to reduce airflow turbulence and a textured exterior for enhanced grip. The hose length can be adjusted using a spring-coil retraction mechanism that allows controlled retraction into a storage compartment.

Various hose nozzle attachments are provided for specialized cleaning tasks, including a narrow crevice tool for confined spaces, a wide lint nozzle for larger debris, and a bristled brush for gentle surface cleaning. The attachments are secured via a snap-fit mechanism and stored in an integrated compartment within the housing, which features flexible grips to hold the attachments in place.

A detachable lint disposal bin with a quick-release latch is positioned below the central unit. The bin is transparent for fill-level monitoring, constructed from anti-static material to prevent lint adherence, and includes a carry handle for convenient disposal. The central unit is powered by a standard 120V electrical outlet via a power cord.

The laundry room vacuum device provides a wall-mounted central vacuum with a high-efficiency, low-noise motor and a multi-stage filtration system that captures fine particles and allergens. The washable mesh pre-filter prevents clogging of the HEPA-rated primary filter, ensuring consistent performance. The crush-resistant hose extends and retracts easily using a spring-coil mechanism, preventing tangles and ensuring durability. Specialized nozzle attachments support targeted cleaning of dryer vents, lint filters, and surrounding areas. The integrated storage compartment securely holds the attachments, while the detachable, transparent, anti-static lint disposal bin enables efficient debris monitoring and disposal. By addressing noise reduction, effective suction, and user convenience, the device offers a comprehensive solution for laundry area maintenance, enhancing both safety and cleanliness.

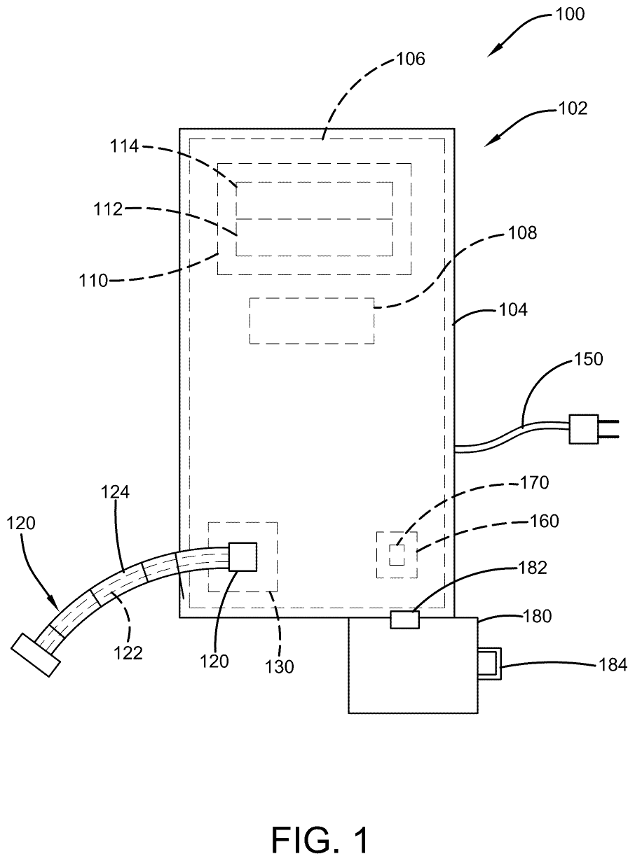

Referring initially to the drawings, FIG. 1 illustrates a front view of one potential embodiment of a laundry room vacuum device 100 of the present invention in accordance with the disclosed architecture. The laundry room vacuum device 100 is comprised of a variety of components designed to optimize the cleaning and maintenance of laundry areas. In the preferred embodiment, the device 100 is comprised of a wall-mounted central unit 102 that includes a housing 104. The housing 104 may further be comprised of internal sound-dampening panels 106 that minimize motor 108 noise and vibration during operation.

The central unit 102 is comprised of at least one high-efficiency, low-noise motor 108 designed to deliver suction while maintaining an operational noise level, preferably below 60 decibels. The unit 102 is also comprised of a filtration system 110 that is preferably a multi-stage filter system configured to capture debris of various sizes. More specifically, the filtration system 110 is comprised of a HEPA-rated primary filter 112 with a pleated, multi-layer structure designed to capture fine particles as small as 0.3 microns, including dust, lint, and allergens. Upstream from the HEPA filter 112 is a secondary washable mesh filter 114 made of stainless steel, which is configured to capture larger lint clumps and prevent premature clogging of the primary filter 112. The mesh filter 114 is removable and capable of withstanding repeated cleaning cycles without degradation.

The device 100 is further comprised of at least one vacuum hose 120 comprised of a reinforced, crush-resistant polymer material featuring a smooth internal lining 122 that minimizes airflow turbulence and prevents lint buildup, as seen in FIG. 1. The exterior surface 124 of the hose 120 is textured for improved grip and durability while remaining flexible. In one embodiment, the hose 120 is adjustable in length via a spring-coil retraction mechanism 126 that allows the hose 120 to retract smoothly when released, ensuring it remains tangle-free. The retraction mechanism 126 pulls the hose 120 back into a storage compartment 130 within the housing 104 at a controlled pace to avoid sudden recoil that could cause damage.

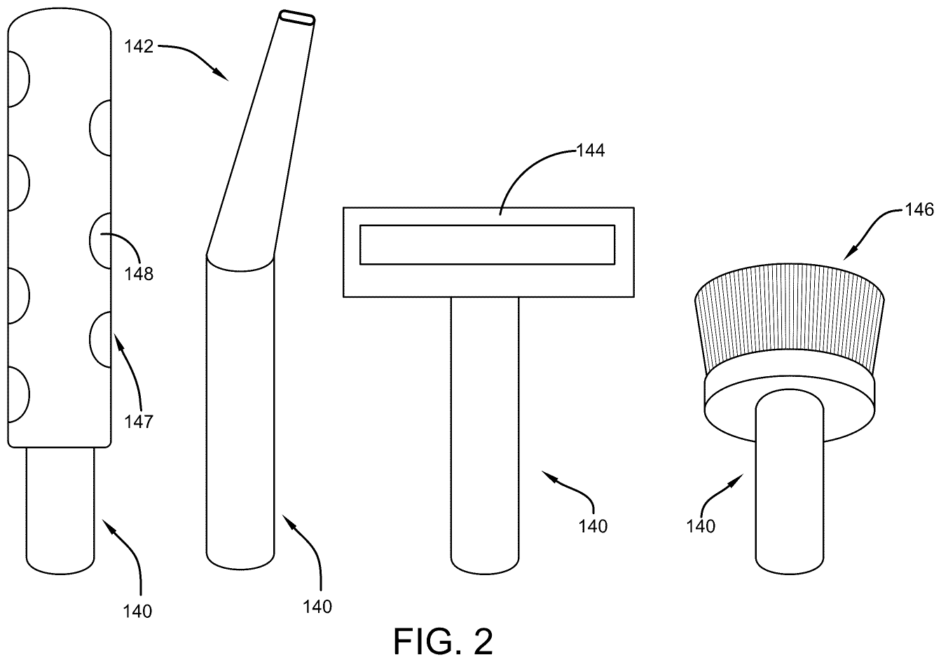

The device 100 is comprised of multiple hose nozzle attachments 140 tailored for specific cleaning tasks, as seen in FIG. 2. In one embodiment, the attachment 140 is comprised of a crevice tool in the form of a narrow nozzle featuring a tapered tip 142 for accessing confined spaces such as lint trap slots, under dryer edges, and between appliances. A wide lint nozzle 140 is comprised of a flat, broad tip 144 with a wide suction opening that captures large amounts of lint from lint screens. A bristled brush attachment 140 is comprised of nylon bristles 146 designed for gentle cleaning around dryer vents, control panels, and appliance exteriors. In various embodiments, the brush head attachment 140 is detachable from the hose 120 via a snap-fit mechanism to facilitate cleaning and replacement. In one embodiment, the attachment 140 has a flexible body 147 comprised of at least one opening 148, preferably positioned near a perimeter edge of the body 147, such that the body can be inserted into narrow crevices/spaces.

An integrated storage compartment 160 within the housing 104 provides designated areas for nozzle attachments 140 when not in use. In one embodiment, the compartment 160 is comprised of at least one fastener 170, such as but not limited to a flexible rubber grip configured to secure the attachments 140 in place. A detachable lint disposal bin 180 is preferably (but not limited to) mounted below the central unit 102 and features a quick-release latch 182 for easy detachment, as seen in FIG. 1. The bin 180 may be transparent to allow users to monitor the fill level of the bin 180. The bin 180 is made of anti-static, durable polymer material to prevent lint from adhering to the interior walls. A carry handle 184 is integrated into the bin 180 design for convenient transport during disposal.

The central unit 102 is configured to be connected to a standard 120V electrical outlet via a power cord 150 in one embodiment.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “laundry room vacuum device” and “device” are interchangeable and refer to the laundry room vacuum device 100 of the present invention.

Notwithstanding the forgoing, the laundry room vacuum device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the laundry room vacuum device 100 as shown in the FIGS. are for illustrative purposes only, and that many other sizes and shapes of the laundry room vacuum device 100 are well within the scope of the present disclosure. Although the dimensions of the laundry room vacuum device 100 are important design parameters for user convenience, the laundry room vacuum device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A laundry room vacuum device comprising:
a wall-mounted central unit comprising a housing;
a motor disposed within the housing;
a filtration system comprising:
a HEPA-rated primary filter; and
a secondary washable mesh filter positioned upstream from the HEPA-rated primary filter;
a vacuum hose;
a retraction mechanism configured to retract the vacuum hose into a storage compartment within the housing; and
a hose nozzle attachment.

2. The laundry room vacuum device of claim 1, wherein the housing is comprised of an internal sound-dampening panel.

3. The laundry room vacuum device of claim 1, wherein the HEPA-rated primary filter is comprised of a pleated, multi-layer structure.

4. The laundry room vacuum device of claim 1, wherein the vacuum hose is comprised of a reinforced, crush-resistant polymer.

5. The laundry room vacuum device of claim 1, wherein the vacuum hose is comprised of a smooth internal lining.

6. The laundry room vacuum device of claim 1, wherein the retraction mechanism is comprised of a spring-coil mechanism.

7. A laundry room vacuum device comprising:
a wall-mounted central unit comprising a housing;
a motor disposed within the housing;
a filtration system comprising:
a HEPA-rated primary filter; and
a secondary washable mesh filter positioned upstream from the HEPA-rated primary filter;
a vacuum hose;
a retraction mechanism configured to retract the vacuum hose into a storage compartment within the housing;
a hose nozzle attachment; and
a lint disposal bin connected to the wall-mounted central unit, the bin comprising an anti-static polymer construction.

8. The laundry room vacuum device of claim 7, wherein the hose nozzle attachment comprises a crevice tool.

9. The laundry room vacuum device of claim 8, wherein the crevice tool is comprised of a tapered tip.

10. The laundry room vacuum device of claim 7, wherein the hose nozzle attachment comprises a wide nozzle.

11. The laundry room vacuum device of claim 7, wherein the hose nozzle attachment comprises a bristled brush.

12. The laundry room vacuum device of claim 7, wherein the lint disposal bin attaches to the wall-mounted central unit via a quick-release latch.

13. The laundry room vacuum device of claim 7, wherein the lint disposal bin is transparent.

14. The laundry room vacuum device of claim 7, wherein the vacuum hose is comprised of a textured exterior surface.

15. The laundry room vacuum device of claim 7, wherein the housing is comprised of an internal sound-dampening panel.

16. The laundry room vacuum device of claim 7, wherein the HEPA-rated primary filter is comprised of a pleated, multi-layer structure.

17. The laundry room vacuum device of claim 7, wherein the vacuum hose is comprised of a reinforced, crush-resistant polymer.

18. The laundry room vacuum device of claim 7, wherein the lint disposal bin is comprised of a carry handle.

19. The laundry room vacuum device of claim 7, wherein the motor has an operational noise level below 60 decibels.

20. A laundry room vacuum device comprising:
a wall-mounted central unit comprising a housing;
a motor disposed within the housing;
a filtration system comprising:
a HEPA-rated primary filter; and
a secondary washable mesh filter positioned upstream from the HEPA-rated primary filter;
a vacuum hose;
a retraction mechanism configured to retract the vacuum hose into a storage compartment within the housing;
a power cord;
a hose nozzle attachment; and
a lint disposal bin connected to the wall-mounted central unit, the bin comprising an anti-static polymer construction.
